(19) United States
(12) Patent Application Publication
(10) Pub. No.: US 2011/0158765 A1
(43) Pub. Date: Jun. 30, 2011

(54) SECURING DEVICE

(76) Inventors: Donna L. Smith, Norco, CA (US); Dean H. Smith, Lafayette, CA (US)

(21) Appl. No.: 12/972,604

(22) Filed: Dec. 20, 2010

Related U.S. Application Data
(60) Provisional application No. 61/290,182, filed on Dec. 25, 2009.

(51) Int. Cl. F16B 39/00

(52) U.S. Cl. 411/373

(57) ABSTRACT

A securing device includes a cylindrical fitting with one open end and a hole in an endwall at the opposite end. The shank of a bolt extends through the hole and is threaded into a mounting hole, e.g., a standard VESA mounting hole on a television or monitor. A no-access cap fits over the head of the bolt, and a generally bar-shaped member used to secure the television or monitor passes through a hole or holes in the side of the fitting. The bar-shaped member prevents the no-access cap from being removed from the fitting, and the no-access cap blocks access to the bolt so that the fitting cannot be removed, thereby deterring theft of the television or monitor. Suitably, a kit is provided with at least one no-access cap and at least one bolt in each of a number of different sizes, e.g., standard VESA mounting sizes.

### CROSS-REFERENCE TO RELATED APPLICATIONS

This application is based on and claims the priority benefit of provisional application 61/290,182 filed Dec. 25, 2009, the contents of which are incorporated by reference.

### BACKGROUND AND FIELD OF THE INVENTION

In general, the invention relates to theft-deterrent securing devices that can be attached to an item to be secured, particularly (but in no way limited to) items such as flat-panel-type televisions (LCD, LED, plasma), computer monitors, solar panels, etc.

The Video Electronics Standards Association (VESA) sets standards for video mounting holes on audio/visual equipment. Manufacturers of monitors have agreed on an industry interface standard, which includes a predetermined bolt-hole pattern on the back of the monitor, screen, or display that fits any mounting device, whether for VESA wall mounts, desktop, or ceiling mounts. Depending on the size of the TV or other audio/visual device to be secured, the screw or bolt size will change. For example, a small 27-inch TV will use M4 screws or bolts; a mid-size TV will use M6 screws; and a large 50-inch to 60-inch TV will use M8 screws.

In certain environments, e.g., public environments such as libraries, schools, internet cafés, etc., it is desirable to secure a television/monitor. While it is known to wrap a cable of some sort around a part of the device to be secured and then securely fasten the opposite end of the cable to some generally immovable or non-easily-transportable object (e.g., a desk, wall, etc.), the cable can, in that situation, interfere with positioning of and/or the ability to view the television/monitor clearly. Therefore, other arrangements for securing such devices are desirable.

### SUMMARY OF THE INVENTION

The invention provides a theft-deterring securing device that is screwed onto an item that is to be secured. The securing device includes a cylindrical fitting with one open end and a hole in an endwall at the opposite end. The shank of a bolt extends through the hole and is threaded into a mounting hole, e.g., a standard VESA mounting hole on a television or monitor. A no-access cap fits over the head of the bolt, and a generally bar-shaped member used to secure the television or monitor passes through a hole or holes in the side of the fitting. The bar-shaped member prevents the no-access cap from being removed from the fitting, and the no-access cap blocks access to the bolt so that the fitting cannot be removed, thereby deterring theft of the television or monitor. Suitably, a kit is provided with at least one no-access cap and at least one bolt in each of a number of different sizes, e.g., standard VESA mounting sizes.

In one aspect, the invention features a securing device kit. The kit includes a cylindrical fitting as described above, a no-access cap, and several (i.e., two or more) bolts of different sizes. Suitably, two or more fittings are provided in the kit, with a no-access cap for each fitting in the kit and a plurality of bolts of different sizes for each fitting in the kit.

In another aspect, the invention features a securing device, per se. The securing device includes a cylindrical fitting as described above, and the no-access cap has a thickness that is sufficient to prevent it from being flipped about an axis once the no-access cap has been inserted into the fitting.

In another aspect, the invention features a securing device, per se. The securing device includes a cylindrical fitting as describe above, and the hole(s) in the fitting sidewall is/are positioned such that when the no-access cap is placed into the fitting as far as possible from the open end, the hole(s) in the fitting sidewall will be located above the no-access cap, between the no-access cap and the open end of the cylindrical fitting, and the hole(s) in the fitting sidewall will be close enough to the no-access cap that, when a generally bar-shaped member extends through the hole(s) in the fitting sidewall and into the interior of the fitting, the bar-shaped member will prevent the no-access cap from being flipped about an axis.

In yet another aspect, the invention features a method for securing a device. The method includes securing a fitting as described above to the object using a bolt, with the shank of the bolt extending out of the fitting and the head of the bolt retained inside the fitting; placing a no-access cap into the fitting so as to cover and block access to the head of the bolt; inserting a generally bar-shaped member through the hole or holes in the fitting sidewall such that the generally bar-shaped member extends into the interior of the fitting, between the no-access cap and the open end of the fitting, and prevents the no-access cap from being removed from the fitting; and using the generally bar-shaped member, securing the device to an immovable or immobile object. The generally bar-shaped member can be a cable or the shackle of a padlock, and the device being secured can be a television, a monitor, a solar panel, etc. Suitably, the fitting, the bolt, and the no-access cap are obtained in a kit and the bolt is selected from among a plurality of bolts of different sizes provided in the kit.

### BRIEF DESCRIPTION OF THE DRAWINGS

The invention will now be described in greater detail in connection with the drawings, in which:

FIG. 1 is parts view of a securing device kit according to the invention, with some of the components shown in perspective;

FIGS. 2, 3, 4, 5a, and 5b are sequential views illustrating the use of the securing device illustrated in FIG. 1, with FIGS. 2, 3, 4, and 5b being top views and FIG. 5a being a side section view; and

FIG. 6 is a view of the rear of a television that has been secured with a pair of the securing devices illustrated in FIG. 1.

### DETAILED DESCRIPTION

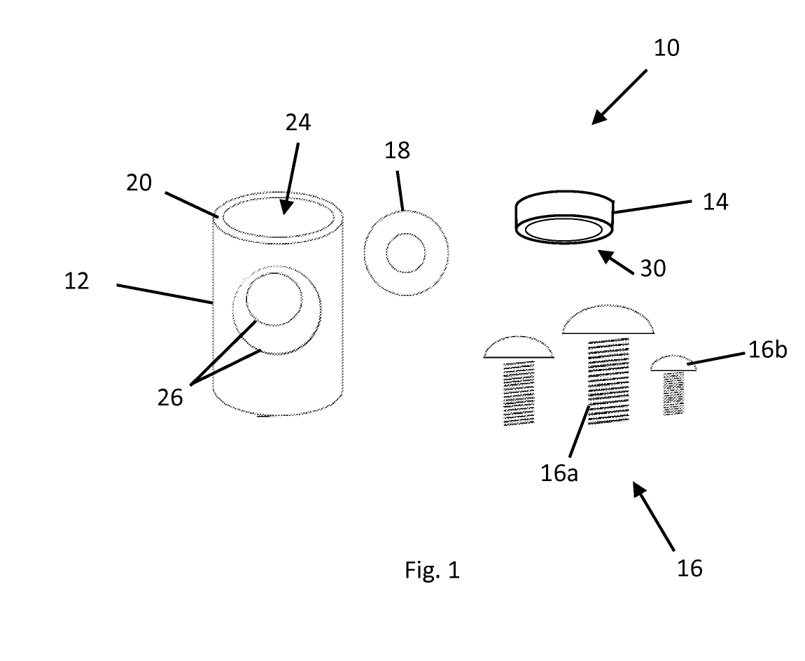

A securing device kit 10 according to the invention is illustrated in FIG. 1. The kit 10 includes at least one cylindrical fitting 12; at least one no-access-cap 14, with one no-access cap 14 provided for each fitting 12 included in the kit; a number of screws or bolts 16 of different sizes (for example, three, as shown), with one bolt of each size provided for each fitting 12 included in the kit; and at least one washer 18, with one or more provided for each fitting included in the kit.

The fitting 12 is generally drinking glass-shaped in that it has a cylindrical sidewall 20, a bottom wall 22, and an open upper end 24. The sidewall 20 has a pair of holes 26 extending through it on generally opposite sides, and the bottom wall 22 has a circular hole 28 extending through it, with the hole 28 being centered in the bottom wall 22.

The no-access cap 14 is generally disc-shaped, with a diameter that is slightly less than the inside diameter of the sidewall 20. Additionally, the no-access cap 14 can have more than just a nominal thickness. More particularly, the no-access cap 14 suitably has a thickness which, given the relative inner diameter of the sidewall 20 and the diameter of the no-access cap 14, precludes the no-access cap 14 from being flipped around a diametric axis. Thus, the closer the diameter of the no-access cap 14 comes to matching the inside diameter of the sidewall 20, the smaller the no-access cap thickness can be while still preventing it from being flipped around a diametric axis; conversely, the more “play” or space there is between the no-access cap 14 and the sidewall 20, the thicker the no-access cap will need to be to prevent it from being flipped. The no-access cap 14 also suitably has a concave or recessed underside 30 so that it fits closely over the head of the bolt 16.

Regarding the bolts 16, the number provided in the kit 10 likely will depend on the application for which the kit 10 is intended. For example, as noted above, three different bolt sizes (M4, M6, and M8) are conventionally used for standard VESA mounting hole arrangements on televisions/monitors. Therefore, a kit 10 that is specifically for televisions/monitors likely will include bolts 16 in three different sizes, namely, at least one M4 bolt, at least one M6 bolt, and at least one M8 bolt, so that one kit 10 can be provided/purchased without the user needing to be concerned about getting a kit with the incorrect bolts. The bolts can be Phillips head bolts (as shown in FIG. 3), hex-socket bolts, or any other desired type of bolts.

Furthermore, to accommodate the various sizes of the bolts 16 included in the kit, the hole 28 in the bottom wall 22 of the cylindrical fitting 12 is suitably large enough for the shank 16a of the largest bolt to pass through it. However, depending on the range of bolt sizes included in the kit 10, it may be the case that the hole 28 has a larger diameter than the head 16b of the smallest bolt included in the kit. Therefore, the washer or washers 18 are provided to block any such excess space around the head or heads of the smaller/smallest bolts in the kit 10 so as to prevent them from passing completely through the hole 28. (Depending on the range of bolt sizes, it may suffice to provide one washer per fitting in the kit, or it may be necessary to provide more than one washer per fitting in the kit in order to accommodate the various bolt sizes that are included.)

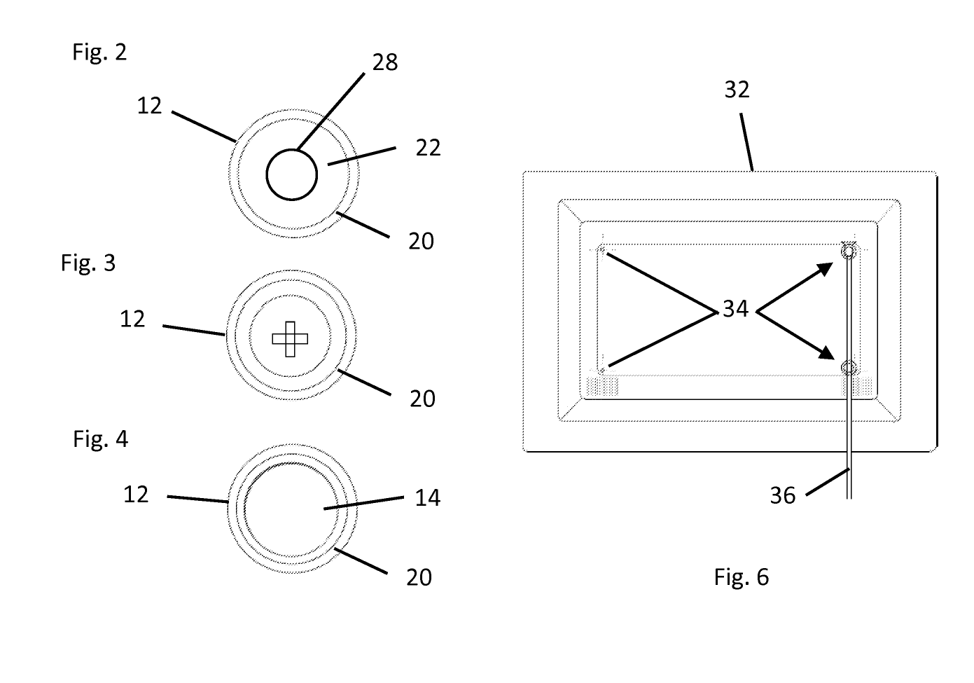

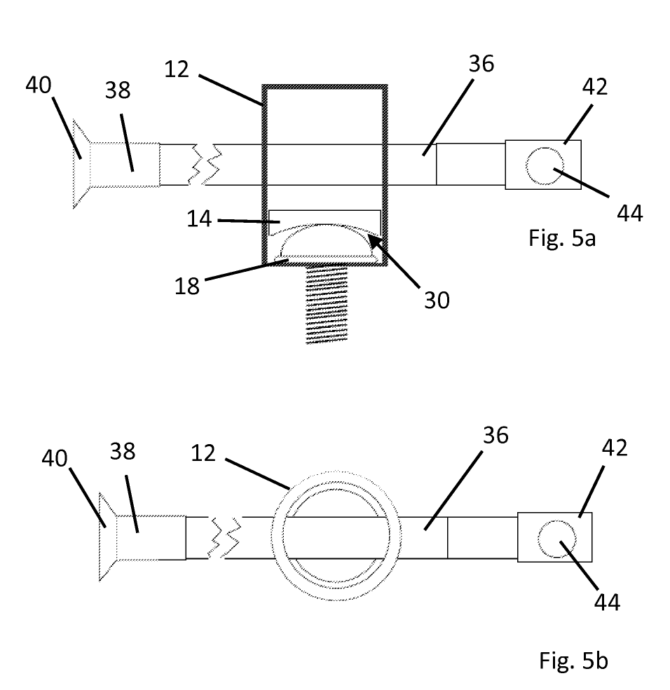

Installation of a securing device according to the invention is illustrated in FIGS. 2-6, in the context of a panel-type television 32 (e.g., plasma, LCD, or LED-LCD). As shown in FIG. 6, the rear of the television 32 has four standard VESA mounting holes 34 arranged in a rectangular configuration (two of which holes are illustrated with a securing device already attached). A bolt 16 of the appropriate size to be screwed into one of the VESA mounting holes on the back of the television 32 is selected from among those provided with the kit 10. If necessary, i.e., if the head 16b of the selected bolt 16 is smaller than the diameter of the hole 28 in the bottom of the cylindrical fitting 12, a washer 18 having an appropriately sized opening—i.e., large enough to allow the shank 16a of the selected bolt 16 to pass through it, but small enough to prevent the head 16b of the selected bolt 16 from passing through it—is inserted into the cylindrical fitting 12 such that it lies flush up against the bottom wall 22 of the fitting, as shown in FIG. 5a. The selected bolt 16 is then inserted into the cylindrical fitting 12, shank-first, such that the shank 16a passes through the hole in the washer 18, if present, and/or the hole 28 in the bottom wall 22 of the fitting 12 (see FIGS. 3 and 5a), and the bolt is then screwed into a selected VESA mounting hole 34 to attach the fitting 12 to the back of the television 32. Once the bolt 16 is tightened securely, the no-access cap 14 is inserted into the cylindrical fitting 12, with the concave underside 30 facing the bolt head 16b, and it is positioned down into the fitting 12 such that the bolt head 16b fits at least partially into the recess in the no-access cap, as shown in FIG. 5a.

Next, a generally bar-shaped member is passed through at least one of the holes 26 in the sidewall 20 of the cylindrical fitting 12, which blocks the no-access cap 14 from being removed from the fitting 12 and hence prevents further access to the bolt 16 to remove the fitting from the television. For example, the generally bar-shaped member can be a flexible cable 36, as illustrated in FIGS. 5a, 5b, and 6. Suitably, the cable 36 has an end fitting 38 fixed (e.g., crimped) onto one end, and the end fitting 38 has a flange 40 that is larger in diameter than the holes 26 in the cylindrical fitting sidewall 20 so as to prevent the end fitting 38 from passing through the holes 26. On the other hand, the cable 36 has another end fitting 42 secured (e.g., crimped) onto the opposite end, and the end fitting 42 is small enough to pass through the holes 26 in the sidewall 20. The end fitting 42 suitably has a hole 44 passing through it, and that hole 44 can be used to secure the cable 36 to a fixed or relatively immobile object, e.g., using a padlock (not shown), with the shackle of the padlock passing through the hole 44; using a pin of some sort passing through the hole 44; etc. Suitably, the cable 36 can be passed through two separate fittings 12 as shown in FIG. 6, with each fitting 12 being secured to the television as described above, and that will provide enhanced security. Alternatively, a chain or a cable with a loop at one end can be used to secure the television by passing a padlock shackle—another type of generally bar-shaped member—through one of the holes 26 in the cylindrical fitting and through the chain or the loop in the cable end before locking the padlock. Thus, in this manner, the television 32 can be secured to the fixed or immobile object, since the one end of the cable 36 is securely attached to the fixed or immobile object and the other end of the cable 36 passes through the holes 26 in the cylindrical fitting 12 and is prevented from being pulled through them by the flange 40, or the padlock shackle passes through one of the holes 26, and the cable 36 or padlock shackle passing through the sidewall 20 of the cylindrical fitting 12, above the top of the no-access cap 14, prevents the no-access cap 14 from being removed to gain access to the bolt.

Finally, as shown in FIG. 5a, the holes 26 in the fitting sidewall 20 are suitably positioned close enough to the open end 24 of the fitting 12 that the bar-shaped member passes over the top surface of the no-access cap 14; that makes the angular or rotational orientation of the no-access cap 14 irrelevant. Additionally, as noted above, the thickness of the no-access cap 14 can be selected such that, given the relative diameters of the no-access cap 14 and the inner diameter of the sidewall 20, the no-access cap cannot be flipped about a diametric axis. As an alternative to that arrangement, or as a feature that is provided in addition to that arrangement, the holes 26 in the cylindrical sidewall 20 can be located far enough from the open end 24 of the fitting such that when the no-access cap 14 is installed over the bolt with the largest head, the top surface of the no-access cap 14 will be located just beneath the holes 26. That way, even if there is a little more space or “play” between the no-access cap 14 and the inner surfaces of the cylindrical sidewall 20, the ability to lift the no-access cap 14 away from the head of the bolt 16 by flipping it about a diametric axis will be eliminated, since the top surface of the no-access cap 14 will contact, and hence by blocked by, any generally bar-shaped member extending through the holes 26 before the no-access cap 14 can be flipped.

It will be apparent that various modifications to and departures from the above-described methodologies will occur to those having skill in the art. What is desired to be protected by Letters Patent is set forth in the following claims.

We claim:

1. A securing device kit, comprising:
a hollow, generally cylindrical fitting having an open end and an opposite end that has an endwall with a hole extending through it, wherein the generally cylindrical fitting has a sidewall with at least one hole extending through it;
a generally disc-shaped no-access cap that is sized to fit within the generally cylindrical fitting; and
a plurality of bolts of different sizes.

2. The securing device kit of claim 1, wherein the kit includes a plurality of generally cylindrical fittings; a no-access cap for each generally cylindrical fitting in the kit; and, for each generally cylindrical fitting in the kit, a plurality of bolts of different sizes.

3. The securing device kit of claim 1, further comprising a washer that is sized to fit within the generally cylindrical fitting and that is sized to prevent the bolt, of said plurality, having the smallest-diameter head from passing through it.

4. The securing device kit of claim 1, wherein each of the plurality of bolts screws into a standard VESA threaded mounting hole.

5. The securing device kit of claim 1, wherein the no-access cap has a concave or recessed major surface.

6. The securing device kit of claim 1, wherein the fitting is round cylindrical and the sidewall has a pair of holes extending through it on opposite sides thereof

7. A securing device, comprising:
a hollow, generally cylindrical fitting having an open end and an opposite end that has an endwall with a hole extending through it, wherein the generally cylindrical fitting has a sidewall with at least one hole extending through it;
at least one bolt with a head and a shank that is sized to fit through the hole in the endwall; and
a generally disc-shaped no-access cap that is sized to fit within the generally cylindrical fitting so as to cover and block access to the head of the bolt;
wherein the hole(s) in the fitting sidewall is/are positioned such that when the no-access cap is placed into the generally cylindrical fitting as far from the open end as possible, the hole(s) in the fitting sidewall will be located above the no-access cap, between the no-access cap and the open end of the cylindrical fitting; and
wherein the no-access cap has a thickness that is sufficient to prevent it from being flipped about an axis once the no-access cap has been inserted into the generally cylindrical fitting.

8. The securing device of claim 7, wherein the bolt screws into a standard VESA threaded mounting hole.

9. The securing device of claim 7, wherein the no-access cap has a concave or recessed major surface.

10. The securing device of claim 7, wherein the fitting is round cylindrical and the sidewall has a pair of holes extending through it on opposite sides thereof

11. A securing device, comprising:
a hollow, generally cylindrical fitting having an open end and an opposite end that has an endwall with a hole extending through it, wherein the generally cylindrical fitting has a sidewall with at least one hole extending through it;
at least one bolt with a head and a shank that is sized to fit through the hole in the endwall; and
a generally disc-shaped no-access cap that is sized to fit within the generally cylindrical fitting so as to cover and block access to the head of the bolt;
wherein the hole(s) in the fitting sidewall is/are positioned such that when the no-access cap is placed into the generally cylindrical fitting as far as possible from the open end, the hole(s) in the fitting sidewall will be located above the no-access cap, between the no-access cap and the open end of the cylindrical fitting, and the hole(s) in the fitting sidewall will be close enough to the no-access cap that, when a generally bar-shaped member extends through the hole(s) in the fitting sidewall and into the interior of the cylindrical fitting, the bar-shaped member will prevent the no-access cap from being flipped about an axis.

12. The securing device of claim 11, wherein the bolt screws into a standard VESA threaded mounting hole.

13. The securing device of claim 11, wherein the no-access cap has a concave or recessed major surface.

14. The securing device of claim 11, wherein the fitting is round cylindrical and the sidewall has a pair of holes extending through it on opposite sides thereof

15. A method of securing a device having a threaded hole, comprising:
using a bolt having a shank and a head, attaching a fitting to the device, wherein the fitting is hollow, generally cylindrical, and has an open end and an opposite end that has an endwall with a hole extending through it; wherein the fitting has a sidewall with at least one hole extending through it; and wherein the fitting is attached to the device by passing the shank of the bolt through the hole in the endwall, such that the shank extends outwardly from the fitting and the head is retained inside the fitting, and screwing the shank into the threaded hole;
placing a no-access cap into the fitting so as to cover and block access to the head of the bolt;
inserting a generally bar-shaped member through the hole in the sidewall such that the generally bar-shaped member extends into the interior of the fitting, between the no-access cap and the open end of the fitting, and prevents the no-access cap from being removed from the fitting; and
using the generally bar-shaped member, securing the device to an immovable or immobile object.

16. The method of claim 15, wherein the generally bar-shaped member is a cable.

17. The method of claim 16, wherein the fitting sidewall has two holes extending through it, on opposite sides thereof, and the cable is passed through both holes in the fitting sidewall.

18. The method of claim 15, wherein the generally bar-shaped member is the shackle of a padlock and the shackle is passed through a link in a chain or a loop in the end of a cable and the chain or cable is attached to the immovable or immobile object.

19. The method of claim 15, wherein the fitting, the bolt, and the no-access cap are obtained in a kit and the bolt is selected from among a plurality of bolts of different sizes provided in the kit.

20. The method of claim 15, wherein the device is selected from the group consisting of a television, a monitor, and a solar panel.
